(19) United States
(12) Patent Application Publication
(10) Pub. No.: US 2019/0112126 A1
(43) Pub. Date: Apr. 18, 2019

(54) SMART JAR

(71) Applicant: MachineThinx Information Technology LLP, Noida (IN)

(72) Inventor: Sudhanshu Dabral, Noida (IN)

(21) Appl. No.: 16/144,356

(22) Filed: Sep. 27, 2018

(30) Foreign Application Priority Data
Sep. 12, 2017 (IN) 201711032299

(51) Int. Cl. B65D 90/48; G01N 29/34; H01M 10/48

(52) U.S. Cl. CPC B65D 90/48; H01M 10/48; G01N 29/34

(57) ABSTRACT

The present disclosure relates to system(s) and method(s) for monitoring material within a storage jar. In one embodiment, the method comprises receiving a first signal and a second signal from one or more accelerometer coupled to a storage jar and obtaining first data associated with a weight of a material within the storage jar, second data associated with one or more parameters of the environment within the storage and outside the storage jar, a historical data of previous weight measurements. The method further comprises computing a creep associated with the load cell based on the second data and the historical data. The method furthermore comprises computing an actual weight of the material within the storage jar based on the creep and the first data, thereby monitoring material within the storage jar.

### CROSS-REFERENCE TO RELATED APPLICATIONS AND PRIORITY

The present application claims the benefit of priority under 35 U.S.C. 119(a) to Indian Patent Application No. 201711032299 entitled “A SMART JAR” filed Sep. 12, 2017, in the Indian Patent Office, which application is incorporated herein by reference.

### TECHNICAL FIELD

The present subject matter described herein, in general, relates to a jar and more particularly a smart jar for monitoring the material within the jar.

### BACKGROUND

The Internet of things (IoT) is the inter-networking of physical devices, vehicles buildings, and other items embedded with electronics, software, sensors, actuators, and network connectivity, which enable these objects to collect and exchange data. Typically, when IoT is augmented with sensors and actuators, the technology becomes an instance of the more general class of cyber-physical systems, which also encompasses technologies such as smart homes, and smart kitchens.

Nowadays, certain consumer markets are buzzing with new concepts such as “Smart Kitchen” and “Smart Healthcare”. In general, kitchen automation or Smart Kitchen refers to the building/development of an automation system for the kitchen, which involves the control and automation of various activities and appliances in the kitchen. Similarly, Smart Healthcare relates to automating processes that connects different players in this ecosystem such as end customers or patients, pharmaceutical firms, hospitals and pharmacies, and medical apparatus and materials. An example of Smart Kitchen is a connected storage jar, which utilizes Wi-Fi to connect and store data about the jar's content to the secured internet cloud. In an example of healthcare, we can have a medicine jar that would connect with Wi-Fi to share data about its content to different players such as pharmacies and/or pharmaceutical firms. Such conventional connected storage jars continuously share data with one or more applications. Furthermore, these conventional connected storage jars fail when utilized in extreme environment and share error prone data. Moreover, these conventional jars also lack any mechanism to eliminate errors induced due to prolonged usage of the connected storage jars.

### SUMMARY OF THE INVENTION

Before the present smart jar(s) for monitoring the material within the jar are described, it must be understood that this application is not limited to the particular assembly described, as there can be multiple possible embodiments, which are not expressly illustrated in the present disclosure. It is also to be understood that the terminology used in the description is for the purpose of describing a few particular implementations, versions, or embodiments only, and is not intended to limit the scope of the present application. This summary is provided to introduce aspects related to smart jar for monitoring the material within the jar. This summary is not intended to identify essential features of the claimed subject matter nor is it intended for use in determining or limiting the scope of the claimed subject matter.

In one implementation, a system for monitoring the content within the jar is disclosed. The system comprises, among other components, a memory and a processor coupled to the memory. The processor may be configured to receive a first signal and a second signal from an accelerometer coupled to a storage jar. Upon receiving, the processor may be configured to obtain, from various sensors, a first data indicative of a weight of a material within the storage jar, a second data associated with one or more parameters of an environment within the storage and an environment outside the storage jar, and fetch, from the memory, a historical data of previous weight measurements. In one example, a first signal may be received when the storage jar experiences a movement and a second signal may be received after completion of the movement. In another example, a first data may be obtained from a load cell, and a second data may be obtained from a set of sensors comprising a temperature sensor, and a humidity sensor. Upon obtaining, the processor may be configured to compute a creep associated with the load cell based on the second data and the historical data. Further to computing the creep, the processor may be configured to compute a corrected actual weight of the material within the storage jar based on the creep computed and the first data, thereby monitoring the content weight within the storage jar.

In one implementation, a method for monitoring the content within the jar is disclosed. In one embodiment, the method comprises of receiving a first signal and a second signal from an accelerometer coupled to a storage jar, and obtaining a first data indicative of a weight of a material within the storage jar, a second data associated with one or more parameters of the environment within and outside the storage jar, and a historical data comprising of previous weight measurement data. In one example, a first signal may be received when the storage jar experiences a movement and a second signal is received after completion of the movement. In one other example, a first data may be obtained from a load cell, and a second data is obtained from a set of sensors comprising a temperature sensor, and a humidity sensor. The method may further include computing a creep associated with the load cell, based on the second data and the historical data. The method may furthermore include computing an actual corrected weight of the material within the storage jar based on the creep and the first data, thereby monitoring content weight within the storage jar.

### BRIEF DESCRIPTION OF THE DRAWINGS

The following detailed description of embodiments is better understood when read in conjunction with the appended drawings. For the purpose of illustration of the present subject matter, an example of construction of the present subject matter is provided as figures; however, the invention is not limited to the specific method and assembly disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1A illustrates a network implementation of a system for monitoring the material within the storage jar, in accordance with an embodiment of the present subject matter.

FIG. 1B illustrates a secondary system installed within the storage jar, in accordance with an embodiment of the present subject matter.

FIG. 2 illustrates another system for monitoring the material within the jar in accordance with an embodiment of the present subject matter.

FIG. 3 illustrates a method for monitoring the material within the jar in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any system and method for monitoring material within a storage jar, similar or equivalent to those described herein, can be used in the practice or testing of embodiments of the present disclosure, the exemplary, a system and a method for monitoring material within a storage jar are now described.

Various modifications to the embodiments will be readily apparent to those skilled in the art and the generic principles herein may be applied to other embodiments for monitoring material within a storage jar. However, one of ordinary skill in the art will readily recognize that the present disclosure for monitoring material within a storage jar is not intended to be limited to the embodiments described, but is to be accorded the widest scope consistent with the principles and features described herein.

The present subject matter relates to a system and method for monitoring material within a storage jar. In a particular embodiment, a first signal and a second signal from one or more accelerometers coupled to a storage jar may be received. More than one accelerometers have been used to make the system more sensitive to disturbance. In one example, the first signal may be received when the storage jar experiences a movement, such as opening the cap or lifting the jar, and the second signal may be received after completion of the movement. Further to receiving, a first data indicative of a weight of a material within the storage jar, a second data associated with one or more parameters of an environment within the storage and an environment outside the storage jar, a stored historical data of previous weight measurements may be obtained. In one example, the first data may be obtained from a load cell, and the second data may be obtained from a set of sensors comprising a temperature sensor, and a humidity sensor. Upon obtaining data from the sensors, a creep associated with the load cell may be computed based on the second data and the historical data. Subsequent to computation, an actual corrected weight of the material within the storage jar may be computed based on the creep and the first data, thereby monitoring actual weight of the material within the storage jar precisely. Further, the disadvantages of the conventional connected jar are overcome, and accurate weight of the material within the jar is provided to the user. In another example, a third data may also be obtained from a set of sensors comprising an ethylene monitoring sensor, and a near infrared sensor. The processor may then be configured to compute composition and freshness of the content, by comparing sensor reading with benchmark reading of freshness indicators stored in system memory. In another implementation of this abstract concept, data about height of content in the storage jar, from an IR sensor in the storage jar, may be used to correct the error in volume calculation from weight data and creep computation. While in certain cases, the first second and third data may be received periodically, without any signals from accelerometers, there could be certain instances where the type of data received may be changed by use of a switching mechanism on the jar.

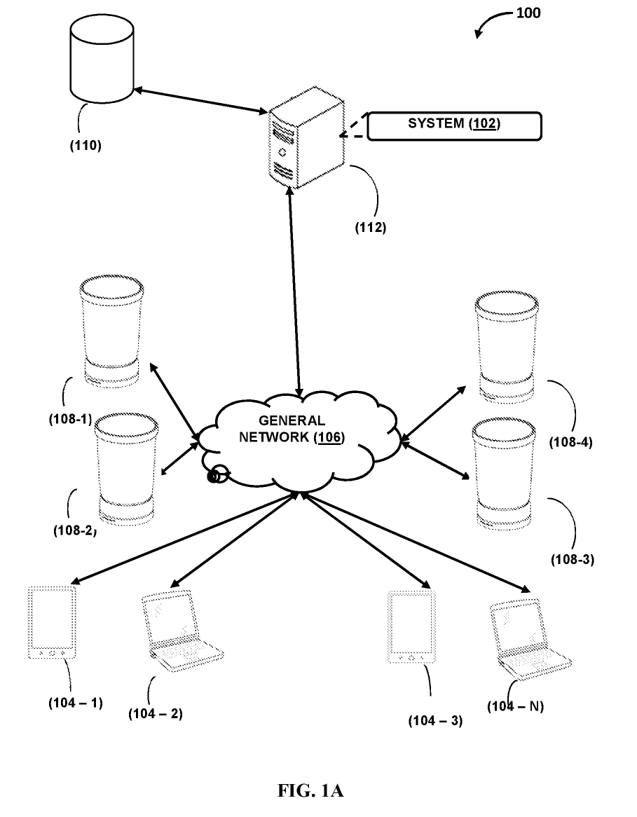

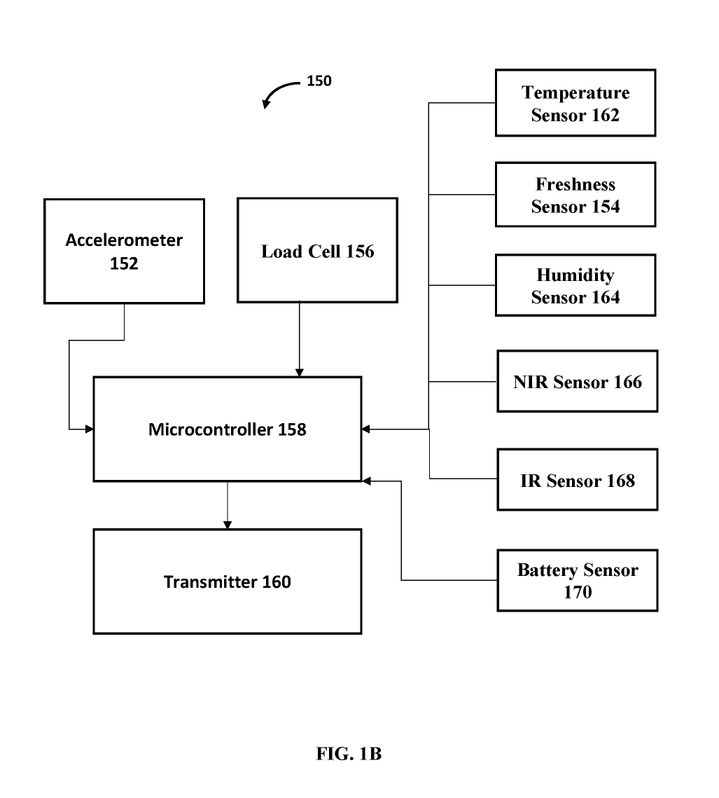

Referring now to FIG. 1A and, an embodiment of a network implementation 100 of a system 102 for monitoring material within storage jars 108-1 . . . 108-N is disclosed. Referring now to FIG. 1B, an embodiment of a secondary system 150 installed within storage jars 108-1 . . . 108-N is disclosed. Although the present subject matter is explained using FIG. 1A and FIG. 1B considering that the system 102 is implemented on a server 110 and the secondary system 150 is installed on with the storage jar 108-1 . . . 108-N, it may be understood that the system 102 may also be implemented in a variety of computing systems, such as a laptop computer, a desktop computer, a notebook, a workstation, a mainframe computer, a server, a network server, and the like, and also the storage jar 108-1 . . . 108-N. In one implementation, the system 102 may be implemented in a cloud-based environment. It must be understood that multiple users may access the system 102 through one or more user device or applications residing on the user device 104-1 . . . 104-N, hereafter individually or collectively referred to as 104. Examples of the user device 104 may include, but are not limited to, a portable computer, a personal digital assistant, a handheld system, and a workstation. The device 104 may be communicatively coupled to a server 110 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), Secure File Transfer Protocol (SFTP), Transmission Control Protocol/Internet Protocol (TCP/IP), Wireless Application Protocol (WAP), and the like, to communicate with one another. Further, the network 106 may include a variety of network systems, including routers, bridges, servers, computing systems, storage systems, and the like.

In the presented embodiment, a system 102 for monitoring material within a storage jar is disclosed. In the said embodiment, the system 102 may receive a first signal and a second signal from an accelerometer 152, in the secondary system 150, (coupled to a storage jar 108) and obtain a first data indicative of a weight of a material within the storage jar 108, a second data associated with one or more parameters of an environment within and outside the storage jar 108, and a historical data of previous weight measurements. In one example, the first signal may be received when the storage jar 108 experiences a movement and the second signal is received after completion of the movement. In other example, the first data may be obtained from a load cell 156, and the second data may be obtained from a set of sensors comprising a temperature sensor 162, and a humidity sensor 164. Upon obtaining, the system 102 may compute a creep associated with the load cell 156 based on the second data and the historical data. Further to computing the creep, the system 102 may compute an actual corrected weight of the material within the storage jar 108 based on the creep and the first data, thereby monitoring material within the storage jar 108. In another example, a third data may be obtained from a set of sensors comprising an ethylene-monitoring sensor 154, and a near infrared sensor 166. Upon obtaining, the processor may be configured to compute composition and freshness of the content, by the way of comparison of data with sample data in the processor. In another example, data from an IR sensor 168 may be used to correct the error in volume calculation from weight data and creep computation.

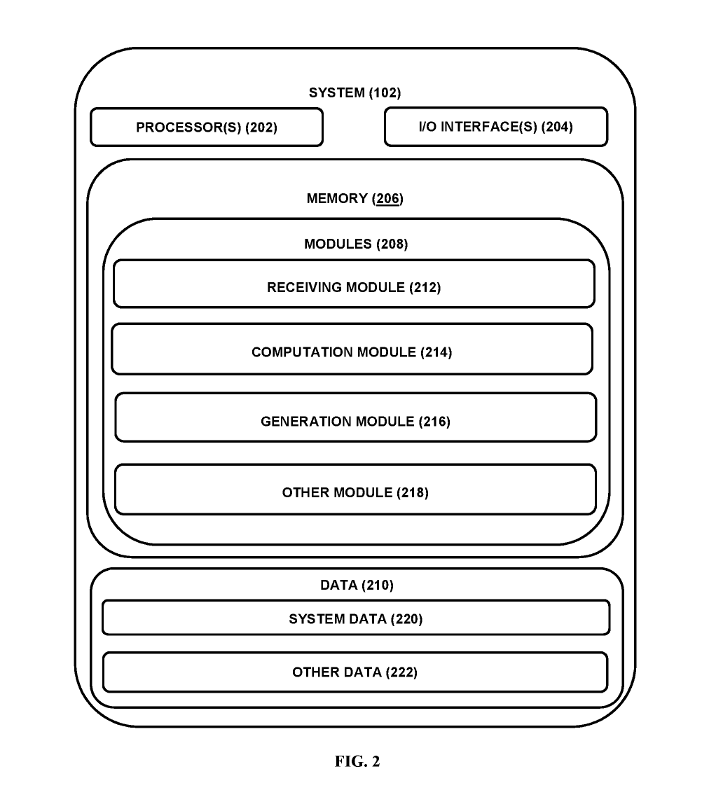

Referring now to FIG. 2, the system 102 for monitoring material within a storage jar is illustrated in accordance with an embodiment of the present subject matter. The system 102 may include at least one processor 202, an input/output (I/O) interface 204, and a memory 206. The processor 202 may be implemented as one or more microprocessors, microcomputers, microcontrollers, digital signal processors, central processing units, state machines, logic circuitries, and/or any systems that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing systems, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of systems to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a receiving module 212, a computation module 214, a generation module 216, and other modules 218. The other modules 218 may include programs or coded instructions that supplement applications and functions of the system 102.

The data 210, amongst other things, serve as a repository for storing data processed, received, and generated by one or more of the modules 208. The data 210 may also include a system data 220, and other data 222. In one embodiment, the other data 222 may include data generated as a result of the execution of one or more modules in the other module 218. In another embodiment, other data 222 may include the historical data of weight measurements.

In one implementation, a user may access the system 102 via the I/O interface 204. The user may be registered using the I/O interface 204 in order to use the system 102. In one aspect, the user may access the I/O interface 204 of the system 102 for obtaining information, providing inputs or configuring the system 102.

### Receiving Module 212

In a particular implementation, the receiving module 212 may receive a first signal and a second signal from one or more accelerometer 152 coupled to a storage jar and store the first signal and the second signal in the system data 220. In one example, more than one accelerometers may be used to make the system more sensitive to disturbance. In one embodiment, one or more accelerometers 152 may be located within the storage jar. In one example, accelerometers located in the cap and in the bottom, may detect any movement of the storage jar and transmit the first signal to be received by the receiving module 212. Further to receiving the first signal, the receiving module may activate a microcontroller 158. The accelerometer 152 may transmit a second signal upon completion of the movement to be received by the receiving module 212. In one other example, the accelerometer 152 may transmit the second signal after a predefined time, such as 5 seconds post completion of the movement. Upon receiving the second signal, the receiving module 212 may instruct the microcontroller 158 to activate the load cell 156 and other sensors. In one example, the other sensors may include a humidity sensor 164, a temperature sensor 162, an infrared sensor 168, a near infrared sensor 166, a freshness sensor 154 and a battery sensor 170. In one embodiment, the other sensors may be located in the bottom of the smart jar and the cap of the smart jar. In one other example, the temperature sensor 162 may also be located outside the smart jar for detecting the room temperature.

Further, in the implementation, the receiving module 212 may obtain a data indicative of a weight of a material within the storage jar from the load cell 156, a second data associated with one or more parameters of an environment within the storage and an environment outside the storage jar, from the temperature sensor 162 and humidity sensor 164 and a historical data of previous weight measurements from other data 222. Further, the receiving module may receive a third data from an infrared sensor 168, a near infrared sensor 166, a freshness sensor 154 and a battery sensor 170. In one embodiment, the third data may comprise of data associated with the current level of the battery, data related to the volume of the material, and composition and freshness of the material in the storage jar. Further, the receiving module 212 may obtain historical data such as previous load cell measurement, creep measurements and the like. The receiving module 212 may further store the first data, the second data, the third data and the historical data in system data 220. Upon obtaining the data, the receiving module 212 may instruct microcontroller 158 to switch off the load cell 158, the humidity sensor 164, the temperature sensor 162, the infrared sensor 168, the near infrared sensor 166, the freshness sensor 154 and the battery sensor 170.

### Computation Module 214

In the implementation, upon obtaining the data, the computation module 214 may compute a creep associated with the load cell based on the second data and the historical data. In one example, computation module 214 may compute the creep by quantifying the creep as a function of measured weights at different time and environmental variants such as humidity and temperature and utilizing a Non-Linear Least Squares regression methodology. Further to computing the creep, the computation module 214 may compute the corrected weight of the material within the storage jar based on the creep and the first data material. In one other example, the computation module 214 may use the equation 1-3 for computing the actual weight.

E=[(L1*W+L2*H+L3*T+L4*H*T)*(L5*Ln(Elapsed days))+L6 1

E=[L1*W*(L5*Ln(Elapsed days))+L6] 2

Actual weight=E+W 3

### Wherein,

H=Humidity, in percentage
T=Temperature, in degree centigrade
D=Elapsed days since the system was activated
W=measure weight by Load cell, in KGs
E=Creep
L1-L5=coefficients of different variables derived from experimental data on the system:
L1=coefficient of the measured value of weight in KG and time
L2=coefficient of the measured value of humidity in percentage
L3=coefficient of the measured value of temperature in degree centigrade
L4=coefficient of the measured value of combined variable of temperature & humidity
L5=coefficient of the log of measured value of time i.e. elapsed time in days
L6=system constant

In one other embodiment, the computation module 214 may compute a total time of storage of the material within the jar based on the historical data, and compare with pre-defined material specific expiry times. In another embodiment, the computation module 214 may compute, a volume of the material using the corrected weight data obtained, and density from the composition data obtained. Further, this computation may be corrected using data from an infrared sensor. In another embodiment, data about the concentration of ethylene gas within the storage jar may be obtained using an ethylene freshness sensor 154, and time of expiry computed. Further, the computation module 214 may also compute the density of the material based on corrected weight data and volume computation mentioned above. In one embodiment, the computation module 214 may cross-reference the composition data and the computed density with sample data in storage module 220 to compute the type and quanta of material inside the jar. Further, upon computing the computation module 214 may store all the computed data in system data 220.

### Generation Module 216

In the embodiment, upon computation, the generation module 216 may generate one or more alerts for the user action and store the alerts in system data 220. In one example, the generation module 216 may compare the received battery level with a predefined threshold and generate an alert if the battery level is below a predefined threshold. In one other example, the generation module 216 may compare the weight of the material in the storage jar with a predefined threshold and generate an alert if the weight of the material is below a predefined threshold. In one more example, the generation module may compare the creep computed with a maximum permissible threshold and generate an alert if it exceed the maximum permissible threshold. In another example, the generation module 216 may generate an alert if the total time of storage of the material exceed one of the expected time of expiry and a shelf life time. In one more example, the generation module 216 may generate an alert if the difference between the actual weight and the secondary weight is over a predefined threshold. Further, the generation module 216 may compare the actual concentration of the ethylene gas, within the storage jar, with a predefined threshold and generate an alert if the actual concertation exceeds the predefined threshold. In may be understood, that based on the one or more of the above-described steps, the monitoring of the material may be enabled, within a storage jar.

Exemplary embodiments for monitoring material within a storage jar discussed above may provide certain advantages. Though not required to practice aspects of the disclosure, these advantages may include those provided by the following features.

Some embodiments of the system and the method enable automation of data collection.

Some embodiments of the system and the method enable automated ordering and purchase of material.

Some embodiments of the system and the method enables accurate weight monitoring.

Some embodiments of the system and the method enable battery monitoring and extending battery life.

Some embodiments of the system and the method enables monitoring of the life of the material within the storage jar.

Some embodiments of the system enable computation of dietary effects of the consumption of the material

Some embodiments of the system may enable the optimization of dietary effects with the material monitoring data

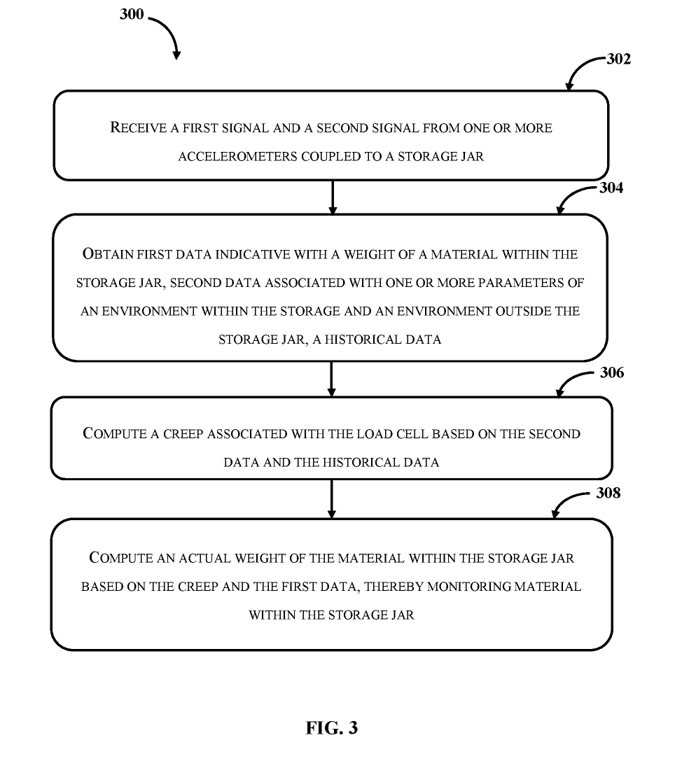

Referring now to FIG. 3, a method 300 for monitoring material within a storage jar, is disclosed in accordance with an embodiment of the present subject matter. The method 300 for monitoring material within a storage jar may be described in the general context of device executable instructions. Generally, device executable instructions can include routines, programs, objects, components, data structures, procedures, modules, functions, and the like, that perform particular functions or implement particular abstract data types. The method 300 for monitoring material within a storage jar may also be practiced in a distributed computing environment where functions are performed by remote processing systems that are linked through a communications network. In a distributed computing environment, computer executable instructions may be located in both local and remote computer storage media, including memory storage systems.

The order in which the method 300 for monitoring material within a storage jar is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 for monitoring material within a storage jar may be considered to be implemented in the above-described embodiment of the system 102.

At block 302, a first signal and a second signal may be received from an accelerometer coupled to a storage jar. In one example, the first signal may be received when the storage jar experiences a movement and the second signal may be received after completion of the movement. In one embodiment, the receiving module 212 may receive the first signal and the second signal. Further, the receiving module 212 may store the first signal and the second signal in the system data 220.

At block 304, a first data indicative of the weight of the material within the storage jar, a second data associated with one or more parameters of an environment within the storage and an environment outside the storage jar, and a historical data may be obtained, based on the second signal. A third data indicative of composition and a fourth data indicative of the freshness may also be obtained. In one example, the first data may be obtained from a load cell, and the second data may be obtained from a set of sensors comprising a temperature sensor, and a humidity sensor. In one example, the third data may be obtained from a near infrared sensor, and the fourth data may be obtained from an ethylene-monitoring sensor. In one embodiment, the receiving module 212 may obtain the first data, the second data, the third data, the fourth data and the historical data. Further, the receiving module 212 may store the first data, the second data, the third data, the fourth data and the historical data in the system data 220.

At block 306, a creep associated with the load cell is computed based on the second data and the historical data. In one embodiment, the computation module 214 may compute the creep associated with the load cell. Further, the computation module 214 may store the creep value in the system data 220.

At block 308, an actual weight of the material within the storage jar may be computed based on the creep and the second data, thereby monitoring material within the storage jar. In one embodiment, the computation module 214 may compute the actual weight of the material within the storage jar, based on the creep and the first data, thereby monitoring material within the storage jar. Further, the computation module 214 may store the actual weight, composition and freshness data in the system data 220.

Although implementations for methods and systems for monitoring material within a storage jar have been described in language specific to structural features and/or methods, it is to be understood that the appended claims are not necessarily limited to the specific features or methods for monitoring material within a storage jar described. Rather, the specific features and methods are disclosed as examples of implementations for monitoring material within a storage jar.

What is claimed is:

1. A method for monitoring material within a storage jar, the method comprises steps of:
receiving, by a processor, a first signal and a second signal from one or more accelerometers coupled to a storage jar, and wherein the first signal is received when the storage jar experiences a movement and the second signal is received after completion of the movement;
obtaining, by the processor, a first data indicative of the weight of the material within the storage jar, a second data associated with one or more parameters of an environment within and outside the storage jar, a historical data of previous weight measurements, wherein the first data, the second data and the historical data is obtained upon receiving the second signal, wherein the first data is obtained from a load cell, and the second data is obtained from a first set of sensors comprising a temperature sensor, and a humidity sensor;
computing, by the processor, a creep associated with the load cell based on the second data and the historical data; and
computing, by the processor, an actual corrected weight of the material within the storage jar based on the creep and the first data, thereby monitoring material weight within the storage jar.

2. The method of claim 1,
comparing, by the processor, the weight of the material and a predefined threshold; and
generating, by the processor, an alert based on the comparison.

3. The method of claim 1, further
receiving, by the processor, a battery level from a battery sensor;
comparing, by the processor, the battery level with a predefined threshold; and
generating, by the processor, an alert if the battery level is below a predefined threshold.

4. The method of claim 1, wherein the second signal is received after a predefined interval post completion of the movement.

5. The method of claim 1 further comprising
activating, by the processor, one or more of the load cell, the temperature sensor, the humidity sensor, a infra-red sensor, a near infrared sensor, a freshness sensor based on the second signal; and
deactivating, by the processor, the one or more of the load cell, the temperature sensor, the humidity sensor, the infrared sensor, the near infrared sensor, the freshness sensor after obtaining one or more data.

6. The method of claim 1,
computing, by the processor, a total time of storage of the material within the jar based on the historical measured weight data;
comparing, by the processor, time of storage and pre-defined, material specific time threshold; and
generating, by the processor, an alert if the total time of storage exceeds pre-defined threshold life time.

7. The method of claim 1, further comprising
receiving, by the processor, a third data from an infrared sensor, a freshness sensor and a near infrared sensor;
computing, by the processor, a volume and quanta of the material, an actual concentration of the ethylene gas within the storage jar and the composition of the material based on the third data; and
generating, by the processor, an alert based on the comparison of the actual concentration of ethylene gas and threshold concentration.
generating, by the processor, an alert based on the comparison of the calculated quanta of the material and threshold level of quanta.

8. A system for monitoring material within a storage jar, the system comprising:
a memory; and
a processor coupled to the memory, wherein the processor is configured to:
receive a first signal and a second signal from one or more accelerometer coupled to a storage jar, wherein the first signal is received when the storage jar experiences a movement and the second signal is received after completion of the movement;
obtain first data indicative of a weight of a material within the storage jar, second data associated with one or more parameters of an environment within the storage and an environment outside the storage jar, a historical data consisting of previous weight measurements; wherein the first data, the second data and the historical data is obtained based upon receiving the second signal, wherein the first data is obtained from a load cell, and the second data is obtained from a set of sensors comprising a temperature sensor, and a humidity sensor;
compute a creep associated with the load cell based on the second data and the historical data; and
compute an actual weight of the material within the storage jar based on the creep and the first data, thereby monitoring material within the storage jar

9. The system of claim 8 further comprising
receiving a battery level from a battery sensor;
comparing the battery level with a predefined threshold; and
generating an alert if the battery level is below a predefined threshold.

10. The system of claim 8, wherein the second signal is received after a predefined interval post completion of the movement.

11. The system of claim 8, further comprising
activating one or more of the load cell, the temperature sensor, the humidity sensor, a infra-red sensor, a near infrared sensor, a freshness sensor based on the second signal; and
deactivating, by the processor, the one or more of the load cell, the temperature sensor, the humidity sensor, the infrared sensor, the near infrared sensor, the freshness sensor after obtaining one or more data.

12. The system of claim 8, further comprising
comparing the weight of the material and a predefined threshold; and
generating, an alert based on the comparison.

13. The system of claim 8, further comprising
computing, by the processor, a total time of storage of the material within the jar based on the historical measured weight data;
comparing, by the processor time of storage and pre-defined, material specific time threshold; and
generating, by the processor, an alert if the total time of storage exceeds pre-defined threshold life time.

14. The system of claim 8, further comprising
receiving a third data from an infrared sensor, a freshness sensor and a near infrared sensor;
computing a volume and quanta of the material, an actual concentration of ethylene gas within the storage jar and the composition of the material based on the third data; and
generating an alert based on the comparison of the actual concentration of ethylene gas and threshold concentration.
generating an alert based on the comparison of the actual quanta of the material and threshold level of quanta.
